(19) United States
(12) Patent Application Publication
(10) Pub. No.: US 2022/0018034 A1
(43) Pub. Date: Jan. 20, 2022

(54) THREE-DIMENSIONAL ELECTRODEPOSITION SYSTEMS AND METHODS OF MANUFACTURING USING SUCH SYSTEMS

(71) Applicant: Battelle Energy Alliance, LLC, Idaho Falls, ID (US)

(72) Inventors: Junhua Jiang, ldaho Falls, ID (US); Robert D. Mariani, Idaho Falls, ID (US)

(21) Appl. No.: 17/309,574

(22) PCT Filed: Dec. 10, 2019
(86) PCT No.: PCT/US2019/065395

§ 371 Date: Jun. 7, 2021

Related U.S. Application Data
(60) Provisional application No. 62/778,093, filed on Dec. 11, 2018.

(51) Int. Cl. C25D 1/00; B33Y 10/00; B33Y 30/00

(52) U.S. Cl. CPC C25D 1/003; B33Y 30/00; B33Y 10/00

(57) ABSTRACT

An electrodeposition system, for additive manufacturing of a three-dimensional structure, includes at least one electrochemical cell. The at least one electrochemical cell includes a receptacle containing an electrolytic bath. At least one nozzle opens from the receptacle toward and proximate a substrate, which is configured as a working electrode of the at least one electrochemical cell. The at least one electrochemical cell also includes a counter electrode disposed in the electrolytic bath. In a method for forming a three-dimensional structure, a metal salt, dissolved in the electrolytic salt, flows through the nozzle to deposit a metal of the metal salt on a surface of the substrate configured as the working electrode. The system may be configured for relative movement between the at least one nozzle and the substrate, enabling additive manufacturing of a three-dimensional structure by electrodeposition.

### CROSS-REFERENCE TO RELATED APPLICATIONS

This application is a national phase entry under 35 U.S.C. § 371 of International Patent Application PCT/US2019/065395, filed Dec. 10, 2019, designating the United States of America and published as International Patent Publication WO 2020/123458 A1 on Jun. 18, 2020, which claims the benefit under Article 8 of the Patent Cooperation Treaty to U.S. Provisional Patent Application Ser. No. 62/778,093, filed Dec. 11, 2018, for “Three-Dimensional Electrodeposition Systems and Methods of Manufacturing Using Such Systems.”

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

Embodiments of the disclosure relate generally to systems and methods for performing electrochemical reactions and processes. More particularly, embodiments of the disclosure relate to systems for performing electrodeposition of three-dimensional structures.

### BACKGROUND

Nuclear reactors are used to generate power (e.g., electrical power) using nuclear fuel materials. For example, heat generated by nuclear reactions carried out within the nuclear fuel materials may be used to boil water, and the steam resulting from the boiling water may be used to rotate a turbine. Rotation of the turbine may be used to operate a generator for generating electrical power.

Nuclear reactors generally include what is referred to as a “nuclear core,” which is the portion of the nuclear reactor that includes the nuclear fuel material and is used to generate heat from the nuclear reactions of the nuclear fuel material. The nuclear core may include a plurality of fuel rods, which include the nuclear fuel material.

Most nuclear fuel materials include one or more of the elements of uranium and plutonium (although other elements such as thorium are also being investigated). There are, however, different types or forms of nuclear fuel materials that include such elements. For example, nuclear fuel pellets may comprise ceramic nuclear fuel materials. Ceramic nuclear fuel materials include, among others, radioactive uranium oxide (e.g., uranium dioxide (UO₂), which is often abbreviated as “UOX”), which is often used to form nuclear fuel pellets. Mixed oxide radioactive ceramic materials (which are often abbreviated as “MOX”) are also commonly used to form nuclear fuel pellets. Such mixed oxide radioactive ceramic materials may include, for example, a blend of plutonium oxide and uranium oxide. Such a mixed oxide may include, for example, U₁₋ₓPuₓO₂, wherein x is between about 0.2 and about 0.3. Transuranic (TRU) mixed oxide radioactive ceramic materials (which are often abbreviated as “TRU-MOX”) also may be used to form nuclear fuel pellets. Transuranic mixed oxide radioactive ceramic materials include relatively higher concentrations of minor actinides such as, for example, neptunium (Np), americium (Am), and curium (Cm). Carbide nuclear fuels and mixed carbide nuclear fuels having compositions similar to the oxides mentioned above, but wherein carbon is substituted for oxygen, are also being investigated for use in nuclear reactors.

In addition to ceramic nuclear fuel materials, there are also metallic nuclear fuel materials. Metallic nuclear fuels include, for example, metals based on one or more of uranium, plutonium, and thorium. Other elements such as hydrogen (H), zirconium (Zr), molybdenum (Mo), and others may be incorporated in uranium- and plutonium-based metals.

In nuclear reactors that employ metallic nuclear fuels, the metallic nuclear fuel is often formed into rods or pellets of predetermined size and shape (e.g., spherical, cubical, cylindrical, etc.) that at least substantially comprise the metallic nuclear fuel. The nuclear fuel material is contained within and at least partially surrounded by a cladding material, which may be in the form of, for example, an elongated tube. The cladding material is used to hold and contain the nuclear fuel. The cladding material typically comprises a metal or metallic alloy, such as stainless steel. During operation of the nuclear reactor, the cladding material may separate (e.g., isolate and hermetically seal) the nuclear fuel bodies from a liquid (e.g., water or molten salt) that is used to absorb and transport the heat generated by the nuclear reaction occurring within the nuclear fuel.

Traditional methods of manufacturing the foregoing nuclear fuel materials include the processing of nuclear fuel powders using so-called dry or wet processes and/or using high temperature (e.g., 1600° C. or greater) melting or laser-beam melting. Such traditional methods result in significant safety and environmental concerns. For example, such high temperature and laser-beam melting processes are associated with high energy expenditures. The dispersion of radioactive nuclear fuel powders to the atmosphere during manufacturing of the nuclear fuel materials also poses a significant safety risk. Traditional machining processes may also include one or more machining steps or leaching steps to remove material from the nuclear fuel materials, and the machining and/or leaching steps generate material waste. Thus, improved systems and methods of manufacturing nuclear fuels that reduce costs, waste, and safety risks are desirable.

### BRIEF SUMMARY

An electrodeposition system, for additive manufacturing of a three-dimensional structure according to embodiments of the disclosure, comprises at least one electrochemical cell. The at least one electrochemical cell comprises a receptacle containing an electrolytic bath. At least one nozzle opens from the receptacle toward and proximate a substrate configured as a working electrode of the at least one electrochemical cell. The at least one electrochemical cell also comprises a counter electrode disposed in the electrolytic bath.

A method of forming a three-dimensional structure, according to embodiments of the disclosure, comprises providing an electrolytic bath in a receptacle. The electrolytic bath comprises a metal salt. A counter electrode is disposed at least partially within the electrolytic bath. The counter electrode is coupled to a working electrode. Metal salt is flowed through a nozzle coupled to the receptacle to deposit, on a surface of the working electrode, a metal of the metal salt.

Also, according to embodiments of the disclosure, an electrodeposition system, for additive manufacturing of a three-dimensional nuclear fuel element, comprises a plurality of electrochemical cells. Each electrochemical cell of the plurality comprises a receptacle, at least one nozzle, and a counter electrode. The receptacle comprises an electrolytic bath. The at least one nozzle opens from the receptacle toward a working electrode of the electrochemical cell. The counter electrode extends into the electrolytic bath. Each electrolytic bath of the system comprises a different composition of nuclear fuel material salt dissolved in ionic liquid at a temperature of less than about 80° C. The working electrode extends below the at least one nozzle of all of the plurality of electrochemical cells.

### BRIEF DESCRIPTION OF THE DRAWINGS

FIG. 1 is a schematic representation of a deposition system, according to embodiments of the disclosure, wherein the system includes an electrochemical cell and at least one controller.

FIG. 2 is a schematic representation of a deposition system, according to embodiments of the disclosure, wherein the system includes an electrochemical cell and at least two controllers.

FIG. 3 is a schematic representation of a deposition system, according to embodiments of the disclosure, wherein the system includes an electrochemical cell and at least three controllers.

FIG. 4 is a schematic representation of a system with a plurality of electrochemical cells, according to embodiments of the disclosure, which plurality of electrochemical cells may be incorporated within a deposition system, such as the systems of any one FIG. 1, FIG. 2, and/or FIG. 3.

FIG. 5 is a schematic, cross-sectional, elevational representation of a nuclear fuel element formed using the system of any of FIG. 1, FIG. 2, FIG. 3, and/or FIG. 4, according to embodiments of the disclosure.

FIG. 6 is a schematic representation of an electrochemical cell that may be incorporated in the system of any of FIG. 1, FIG. 2, FIG. 3, and/or FIG. 4, according to embodiments of the disclosure.

FIG. 7A and FIG. 7B are schematic polarization curves for the electrodeposition of compounds using the system of any of FIG. 1, FIG. 2, FIG. 3, and/or FIG. 4.

### DETAILED DESCRIPTION

Systems and methods disclosed herein enable fabrication of three-dimensional structures, such as nuclear fuel elements, by additive manufacturing through electrodeposition using at least one electrochemical cell. The electrodeposition of, e.g., nuclear material, may be accomplished at relatively low temperatures, with less risk of dispersion of radioactive nuclear fuel material into the atmosphere during manufacturing, with less material waste, with less energy expenditure, with less expense, and with increased safety.

The following description provides specific details, such as compositions, materials, processing conditions, equipment, and features thereof, in order to provide a thorough description of embodiments described herein. However, a person of ordinary skill in the art will understand that the embodiments disclosed herein may be practiced without employing these specific details. Indeed, the embodiments of the disclosure may be practiced in conjunction with conventional fabrication techniques employed in the industry. In addition, the description provided below does not form a complete process flow, apparatus, or system for forming a component of a nuclear reactor, another structure, or related methods. Only those process acts and structures necessary to understand the embodiments of the disclosure are described in detail below. Additional acts to form a component of a nuclear reactor core or another structure may be performed by conventional techniques. Further, any drawings accompanying the present application are for illustrative purposes only and, thus, are not necessarily drawn to scale.

The illustrations included herewith are not meant to be actual views of any particular systems or structures formed with the systems, but are merely idealized representations that are employed to describe embodiments herein. Elements and features common between figures may retain the same numerical designation.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, even at least 99.9% met, or even 100.0% met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0% to 110.0% of the numerical value, such as within a range of from 95.0% to 105.0% of the numerical value, within a range of from 97.5% to 102.5% of the numerical value, within a range of from 99.0% to 101.0% of the numerical value, within a range of from 99.5% to 100.5% of the numerical value, or within a range of from 99.9% to 100.1% of the numerical value.

As used herein, “and/or” includes any and all combinations of one or more of the associated listed items.

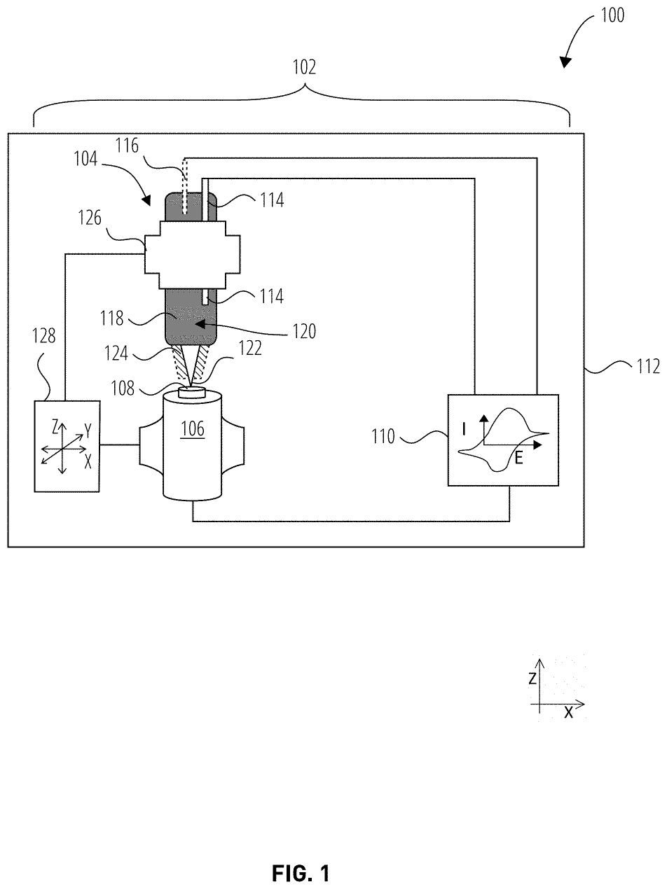

Embodiments of the disclosure relate to systems and related methods for manufacturing (e.g., depositing, forming) a three-dimensional structure. FIG. 1 illustrates a schematic of a system 100, according to embodiments of the disclosure. The system 100 comprises an electrochemical processing unit 102, which includes an electrochemical cell 104 that includes a substrate 106 (e.g., a platform) on which a three-dimensional (3D) structure 108 may be formed. The electrochemical processing unit 102 also comprises at least one controller (e.g., controller 110). One or more of the components of the electrochemical processing unit 102, such as one or more of the electrochemical cell 104, the substrate 106 thereof, the structure 108, and the controller 110 may be enclosed within a reaction chamber 112 (e.g., a radioactive shield).

The electrochemical cell 104 of the electrochemical processing unit 102 includes multiple electrodes. The substrate 106 of the electrochemical cell 104 serves as a working electrode. A counter electrode 114 is also included and, in some embodiments, also a reference electrode 116.

The electrochemical cell 104 of the electrochemical processing unit 102 further includes a container 118 (e.g., a receptacle), such as a crucible, in which an electrolytic bath 120 is retained. The reference electrode 116, if included, and the counter electrode 114 may be at least partially disposed in the electrolytic bath 120. At least one nozzle 122 may be coupled to the container 118. In some embodiments, a heater 124 (e.g., an induction heater or a heating block, either of which can be controlled by a temperature control unit) may be coupled to and disposed about the nozzle 122 and/or about the substrate 106 (e.g., the working electrode). In some embodiments, the heater 124 may comprise an induction heater that laterally surrounds each nozzle 122.

The substrate 106 (e.g., the working electrode) may be disposed proximate to the nozzle 122 such that one or more elements of the electrolytic bath 120 may be deposited through the nozzle 122 and onto a surface of the substrate 106. Another container (not illustrated) may be included in the electrochemical processing unit 102 and may contain at least the surface of the substrate 106, the structure 108 during its formation, and at least a lowest part of the nozzle 122. Such other container may be formed of steel, glass, plastic, or the like.

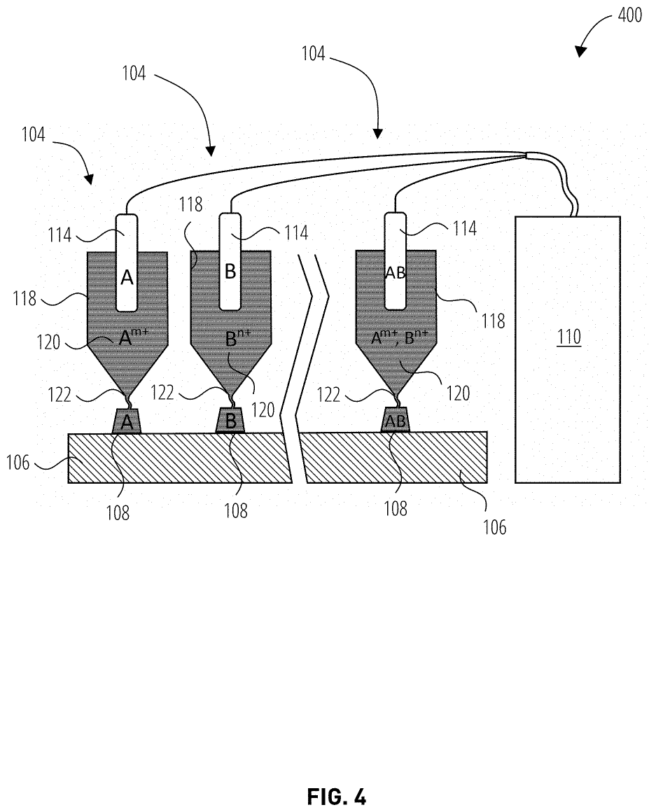

One or more of the substrate 106, the counter electrode 114, the reference electrode 116 (if included), and the nozzle 122 may be selected to comprise silver, titanium, gold, and/or a boron-containing material such as borosilicate glass, boron carbide, and high-boron steel. In some embodiments, the counter electrode 114 may be selected to comprise a. metal substantially similar to a composition of a metal to be deposited using the system 100, as described further, below, with reference to FIG. 4. In further embodiments, one or more of the substrate 106 (e.g., the working electrode), the counter electrode 114, and the reference electrode 116 (if included) may be selected to comprise a material compatible with a composition (e.g., chemistry) of the structure 108 being fabricated using the system 100.

In a method for using the system 100, according to embodiments of the disclosure, a voltage differential is selected and is applied by the controller 110 such that a proportional (e.g., corresponding) current flows from the substrate 106 (e.g., the working electrode) to the counter electrode 114. In other embodiments, a current is selected and is flowed by the controller 110 and a proportional voltage differential is applied between the substrate 106 (e.g., the working electrode) and the counter electrode 114.

One or both of the substrate 106 and the container 118 of the electrochemical cell 104 may be coupled to an electromechanical arm 126 such that the substrate 106 and the container 118 may be configured to move in the x-direction (i.e., left and right, along arrow X, in the view illustrated in FIG. 1), the y-direction (i.e., into and out of the page in the view illustrated in FIG. 1), and the z-direction (i.e., up and down, along arrow Z, in the view illustrated in FIG. 1). As the container 118 is moved in this fashion, the nozzle 122 is also moved in the same direction, e.g., over the upper surface of the substrate 106 and along the structure 108 supported by the substrate 106,

In some embodiments, the electromechanical arm 126 may also be configured to control movement of the substrate 106 (and therefore also the structure 108), such as by rotating the substrate 106. Accordingly, the electromechanical arm 126 of such embodiments may rotate the substrate 106 and/or the container 118 (and nozzle 122) about any or each axis of movement (e.g., the x-, y-, and z-directions) such that the electromechanical arm 126 may also be able to pitch, roll, etc. The electromechanical arm 126 may be configured to manipulate the movement of the substrate 106 (and therefore also the structure 108) and the container 118 (and therefore also the nozzle 122) either jointly (e.g., as the substrate 106 is moved in a certain direction, the container 118 is also moved in the same direction) or independently (e.g., enabling the substrate 106 to be moved in one directly while the container 118 is motionless or moved in a different direction).

In some embodiments, the electrochemical processing unit 102 of the system 100 also includes an XYZ platform 128 that may support the substrate 106 (and therefore also the structure 108). In such embodiments, the XYZ platform 128 may be configured to be manipulated to control the movement of the substrate 106 (and therefore also the structure 108), while the electromechanical arm 126 may be dedicated for controlled manipulation of the container 118 (and therefore also the nozzle 122).

At least one of the controllers of the at least one controller of the system 100, e.g., the controller 110 of FIG. 1, may be in operable communication with the electromechanical arm 126. Therefore, the controller 110 may be configured to control the movement of the electromechanical arm 126 and therefore the movement of at least the container 118 and the nozzle 122. In embodiments in which the electromechanical arm 126 is also operatively connected to the substrate 106, the controller 110 may also be configured to control the movement of the substrate 106 and therefore the movement of the structure 108. In other embodiments in which the XYZ platform 128 is included and is operatively connected to the substrate 106, the controller 110 may be configured to control the movement of the XYZ platform 128 and therefore the movement of the substrate 106 and the structure 108.

FIG. 1 illustrates a system (e.g., system 100) with one controller (e.g., controller 110) for controlling the voltage differential and current flow to/between the substrate 106 (e.g., the working electrode), the counter electrode 114, and the reference electrode 116 (if included). In other embodiments, however, the more than one controller may be included in the system.

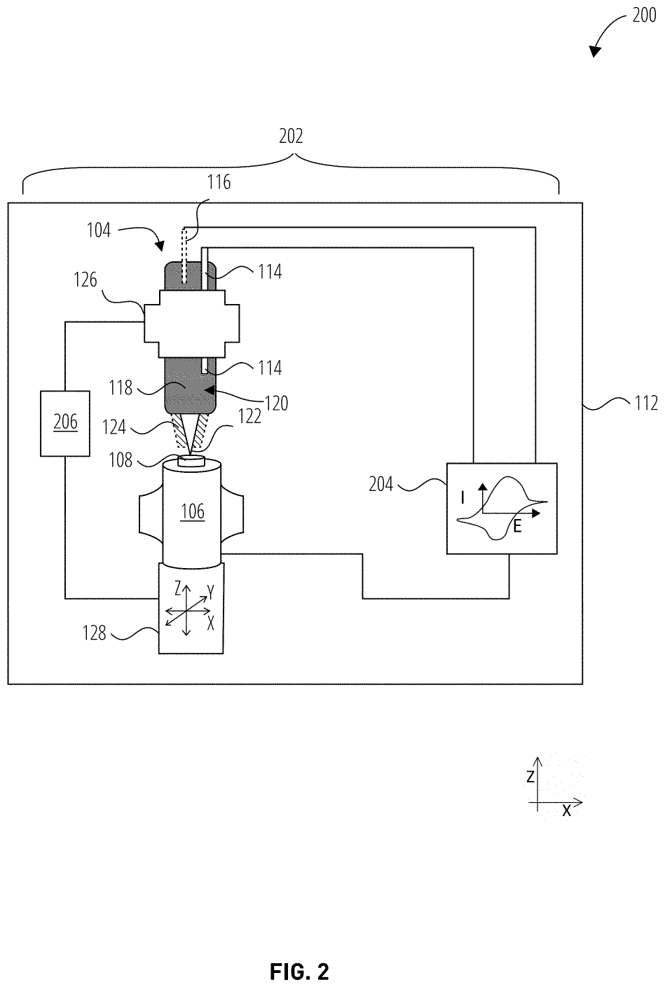

For example, FIG. 2 illustrates a system 200 with an electrochemical processing unit 202 that includes the electrochemical cell 104 and two controllers: a first controller 204 and a second controller 206. The first controller 204 may be configured to control the voltage differential and current flow to/between the substrate 106 (e.g., the working electrode), the counter electrode 114, and the reference electrode 116 (if included). The second controller 206 may be configured to control the movement of both the electromechanical arm 126 (and therefore the container 118 and the nozzle 122) and the XYZ platform 128 (and therefore the substrate 106 and the structure 108).

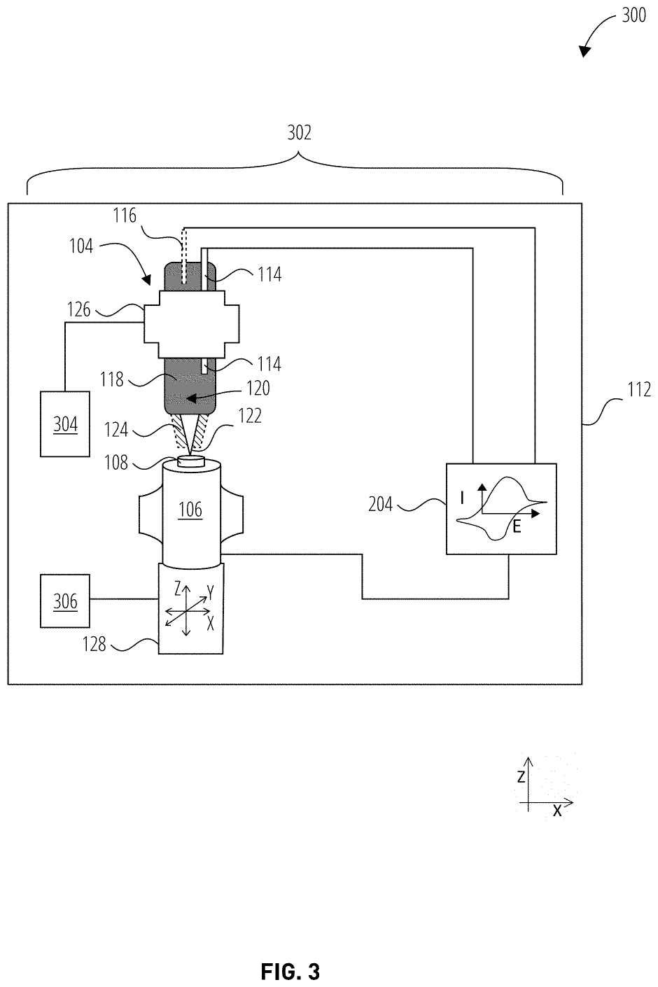

As another example, FIG. 3 illustrates a system 300 with an electrochemical processing unit 302 that includes the electrochemical cell 104 and three controllers: the first controller 204, a second controller 304, and third controller 306. As in the system 200 of FIG. 2, the first controller 204 may be configured to control the voltage differential and current flow to/between the substrate 106 (e.g., the working electrode), the counter electrode 114, and the reference electrode 116 (if included). The second controller 304 may be configured to control the movement of the electromechanical arm 126 (and therefore the container 118 and the nozzle 122). The third controller 306 may be configured to control the movement of the XYZ platform 128 (and therefore the substrate 106 and the structure 108).

In still other embodiments, one or more additional controllers may be included in the system to control additional system equipment, such as to control the heat applied e.g., to the nozzle 122) by the heater 124. Alternatively, one or more of the aforementioned controllers (e.g., the controller 110 of the system 100 of FIG. 1; the first controller 204 or the second controller 206 of the system 200 of FIG. 2; or the first controller 204. the second controller 304, or the third controller 306 of the system 300 of FIG. 3) may be additionally configured to control operation of other system equipment, such as the heat applied to the nozzle 122 by the heater 124.

Any or all of the aforementioned controllers (e.g., the controller 110 of the system 100 of FIG. 1; the first controller 204 or the second controller 206 of the system 200 of FIG. 2; or the first controller 204, the second controller 304, or the third controller 306 of the system 300 of FIG. 3) may be or include a potentiostat, a galvanostate, a power source, such as a DC power supply, or other instrumentation to control the operation of the corresponding system component (e.g., with regard to the controller 110 of FIG. 1 or the first controller 204 of FIG. 2 or FIG. 3, to control the current flow and/or a voltage (e.g., potential difference) applied between the substrate 106 (e.g., the working electrode) and the counter electrode 114).

In some embodiments, the substrate 106 may be supported on (e.g., directly on top of) the XYZ platform 128, as illustrated in FIG. 2 and FIG. 3. In other embodiments, the XYZ platform 128 may he incorporated within (e.g., be integral to) the substrate 106.

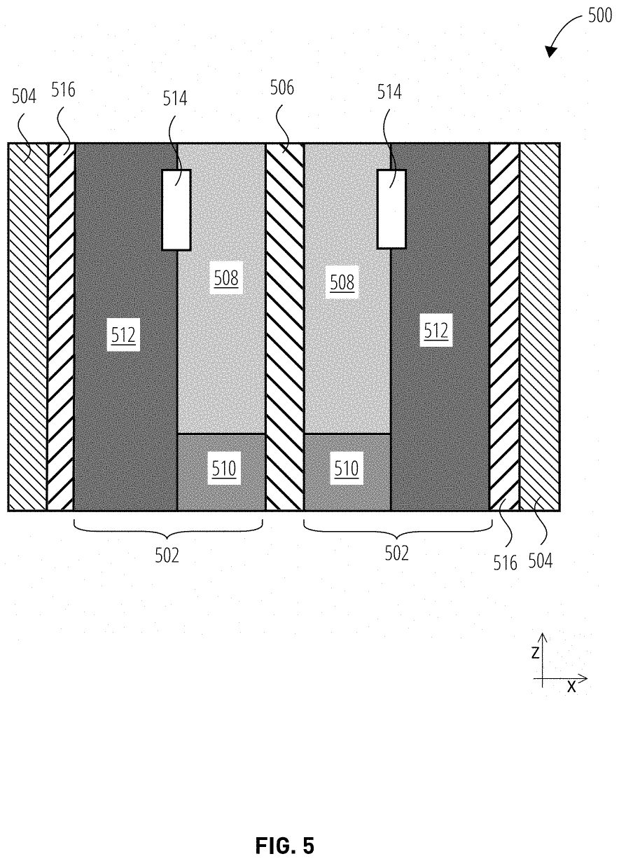

In some embodiments, the reaction chamber 112 may comprise a radioactive shield configured to contain radioactive materials that may be used to manufacture the structure 108 therein. The reaction chamber 112 may also be configured to provide a controlled environment in which the nuclear fuel element 500 of FIG. 5, described below, may be manufactured.

While the system 100 of FIG. 1, the system 200 of FIG. 2, and the system 300 of FIG. 3 are illustrated as having as having a single electrochemical cell 104, the disclosure is not so limited. As illustrated in FIG. 4, a system 400 may include a plurality of electrochemical cells 104 coupled to one or more controllers, such as the controller 110. The system 400 may further comprise the substrate 106 (e.g., the working electrode), which may be a single substrate 106 for use with all of the electrochemical cells 104, as illustrated in FIG. 4. Or, in other embodiments, each electrochemical cell 104 may include a separate substrate 106, or some of the electrochemical cells 104 may share a substrate 106 what others of the electrochemical cells 104 have their own substrate 106. The system 400 may also include one or more electromechanical arm 126 and/or one or more XYZ platform 128 for one, all, or some of the electrochemical cells 104 and/or one, all, or some of the structures 108 being fabricated.

Each of the electrochemical cells 104 may comprise a respective container 118, nozzle 122, and, optionally, a heater 124 (FIG. 1, FIG. 2, FIG. 3). A plurality of the electrochemical cells 104 may be provided within the system 400 (or in instead and in place of the single electrochemical cell 104 of the system 100 of FIG. 1, the system 200 of FIG. 2, or the system 300 of FIG. 3) and within the reaction chamber 112 (FIG. 1, FIG. 2, FIG. 3). In some embodiments, each respective container 118 may contain an electrolytic bath 120 having a different composition (e.g., composition A^{m+}, composition Bⁿ⁺, composition A^{m+}+Bⁿ⁺). Accordingly, a plurality of electrochemical cells 104 may concurrently manufacture one or more individual structures 108 (e.g., the structure 108 of composition “A,” the structure 108 of composition “B,” and the structure 108 of composition “AB”) or one or more portions (e.g., regions) of the same structure (e.g., concurrently). In other embodiments, more than one nozzle 122 and, optionally, respective heater 124 (FIG. 1, FIG. 2, FIG. 3) may be coupled to a single container 118 of a single electrochemical cell 104.

The electrolytic bath 120 of any of the aforementioned electrochemical cells 104 may comprise a room temperature ionic liquid formulated to permit the flow of electricity therein. The ionic liquid may include hydrogen and/or carbon, each of which is capable of providing shielding against gamma and neutron radiation and of preventing the transportation of air-borne radioactive elements, when such radioactive elements are dissolved in the electrolytic bath 120 for deposition by the system e.g., system 100 of FIG. 1, system 200 of FIG. 2, system 300 of FIG. 3, system 400 of FIG. 4). In some embodiments, the ionic liquid of the electrolytic bath 120 may comprise nitrogen-containing cations, such as imidazolium and nitrogen-, bromine-, or boron-containing anions, such as dicyanamide anion (N(CN)₂⁻), bromine (Br⁻), and tetrafluoroborate (BF₄⁻). By way of non-limiting example, the electrolytic bath 120 may comprise an imidazolium-based ionic liquid including 1-butyl-3-methylimidazolium tetrafluoroborate and 1-ethyl-3-methylimidazolium bromide. In such embodiments, the ionic liquid composition of the electrolytic bath 120 may have the advantage of higher neutron absorption cross-sections and may offset the moderator effects of hydrogen and/or carbon in the electrolytic bath 120. The electrolytic bath 120 may further comprise an electrolyte, or salt. Such salts may include, for example, AlBr₃, LiBF₄, LiBr, KBr, and CsBr. Salts such as LiBr and LiBF₄ may also have the advantage of offsetting the moderator effects of hydrogen and carbon included in the electrolytic bath 120.

In some embodiments, the system (e.g., the system 100 of FIG. 1, the system 200 of FIG. 2, the system 300 of FIG. 3, the system 400 of FIG. 4) is operated so as to form a nuclear fuel element such as the nuclear fuel element 500 of FIG. 5. Accordingly the electrolytic bath 120 may have one or more elements, dissolved in the ionic liquid of the electrolytic bath 120, of nuclear material to be included in the nuclear fuel element 500 to be fabricated.

With reference to FIG. 5, illustrated is a nuclear fuel element 500 that may be fabricated in whole or in part using a system (e.g., the system 100 of FIG. 1, the system 200 of FIG. 2, the system 300 of FIG. 3, the system 400 of FIG. 4) and a method of embodiments of the disclosure. FIG. 5 illustrates the nuclear fuel element 500 in elevational cross-section. The nuclear fuel element 500 may be cylindrically shaped, boxed shaped or the like.

The nuclear fuel element 500 may comprise a nuclear fuel 502 surrounded by cladding 504. A sensor 506 may be embedded within the nuclear fuel 502. The nuclear fuel 502 of the nuclear fuel element 500 may be formed, using the systems and methods of embodiments of the disclosure, to exhibit composition, chemical, or morphological (e.g., microstructural) differences in different regions along a height (e.g., in the “Z” direction), and/or across a width (e.g., in the “X” direction) thereof. In some embodiments, the differences may be in the form of gradients along the height and/or cross the width, or portions thereof. For example, the nuclear fuel 502 may be formed, using the systems and embodiments of the disclosure, to form regions of varying microstructures along a length and/or across a width thereof. Thus, the nuclear fuel element 500 may include a nuclear material (e.g., a uranium-based nuclear material, such as a uranium-zirconium (UZr) material) with a porous microstructure in a porous zone 508, a less-porous/more-dense microstructure in a less-porous zone 510, and a dense microstructure in a dense zone 512.

In some embodiments, the electrochemical cell 104 is used for fabricating uranium-zirconium fuel elements, such as the nuclear fuel element 500 of FIG. 5. Using the methods of embodiments of this disclosure, the nuclear fuel element 500 may be fabricated to include the dense zone 512 as a uranium-rich zone. Moreover, parasitic neutron-capturing elements, such as a burnable absorber 514 (e.g., poison material) may be embedded or distributed in the nuclear fuel 502. The cladding 504 may comprise stainless steel, and a barrier layer 516 (e.g., of zirconium) may be provided between the nuclear fuel 502 and the cladding 504.

A nuclear fuel element such as the nuclear fuel element 500 may be additively manufactured, using any of the systems and methods described herein. For example, in some embodiments, the nuclear fuel element 500 may be additively formed, through electrodeposition of the material of the nuclear fuel element 500, in layer-by-layer fashion in the z-direction. In some such embodiments the nuclear material of the less-porous zone 510, the porous zone 508, and the dense zone 512 may be electrodeposited in conjunction with one another, either also in conjunction with the material of the sensor 506 or with the sensor 506 inserted into the nuclear fuel 502 after the nuclear fuel 502 has been fabricated. The burnable absorber 514 may be inserted after or while fabricating the nuclear fuel 502. In some embodiments, the barrier layer 516 may be electrodeposited, in layer-by-layer fashion, along with the electrodeposition, in layer-by-layer fashion, of the nuclear fuel 502. Alternatively, after forming the nuclear fuel 502, it may be inserted within a tube comprising the barrier layer 516 and the cladding 504.

The material of the nuclear fuel 502 may comprise aluminum-uranium alloys, uranium-zirconium alloys (e.g., U—Zr, U—Pu—Zr) and/or may comprise oxide fuels (e.g., UO₂, U₃O₈, and PuO₂—UO₂). Accordingly, the electrolytic bath 120 may include, but is not limited to, salts of uranium, aluminum, zirconium, cesium, plutonium, chlorine, and/or oxygen dissolved therein, with the composition of the electrolytic bath 120 tailored according to the composition of the material to be electrodeposited.

Overall, by using an ionic bath for the electrolytic bath 120, the structure 108 (or structures 108), such as the structure of the nuclear fuel element 500 of FIG. 5, or the sub-structures thereof, may be formed at relatively low temperatures compared to traditional manufacturing processes. Using a system disclosed herein (e.g., system 100 of FIG. 1, system 200 of FIG. 2, system 300 of FIG. 3, system 400 of FIG. 4), the electrodeposition process may be conducted at relatively low temperatures, such as temperatures of 80° C. or less, including room temperatures (e.g., about 20° C. to about 25° C.). Moreover, any radioactive materials to be electrodeposited by the system may be dissolved in the electrolytic bath 120. As a result, the radioactive materials may be highly confined and less susceptible to dispersion to the manufacturing atmosphere, compared to conventional powder deposition processes.

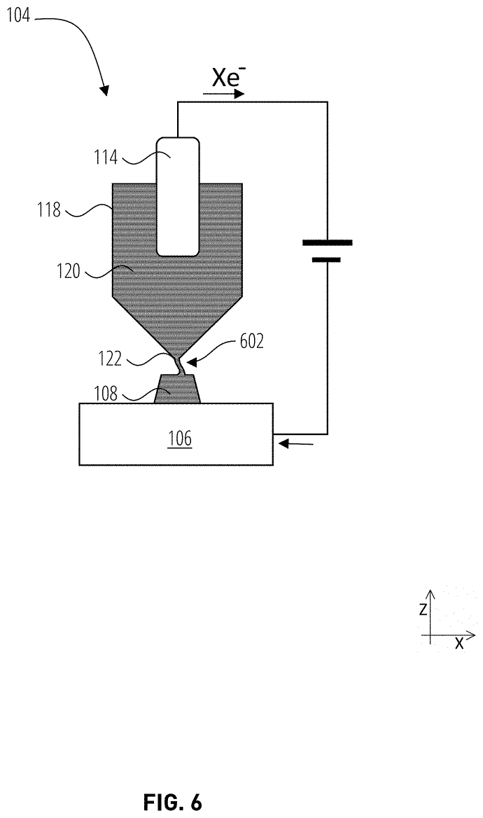

FIG. 6 illustrates an electrochemical cell 104 in use during an electrodeposition process to form (e.g., deposit, manufacture) the structure 108 (e.g., the nuclear fuel element 500 of FIG. 5 or materials thereof) on the substrate 106, according to embodiments of the disclosure. In the electrodeposition process, the substrate 106, e.g., the working electrode, serves as a cathode and the counter electrode 114 serves as an anode. In the presence of a voltage (e.g., potential difference) applied and a current flow (counter to electron flow as indicated by arrow “Xe⁻”), controlled by the controller 110 (FIG. 1) (or the first controller 204 of FIG. 2 or FIG. 3), ions (e.g., metal salts) in the electrolytic bath 120 migrate from the electrolytic bath 120 in the container 118, through the nozzle 122, to the substrate 106 (e.g., the working electrode) at which an electron-transfer reaction occurs to deposit the material of the structure 108. As more and more material is deposited in this manner, the structure 108 increases in size. By moving the container 118 (and therefore also the nozzle 122) relative to the structure 108 (and therefore also the substrate 106), such as by operation of the electromechanical arm 126 (FIG. 1, FIG. 2, FIG. 3)—or, alternatively or additionally, by moving the substrate 106 (and therefore also the structure 108) relative to the container 118 (and therefore also the nozzle 122), such as by operation of the XYZ platform 128 (FIG. 1, FIG. 2, FIG. 3)—the material of the structure 108 is deposited where additions to the structure 108 are desired, resulting in fabrication of a three-dimensional structure (e.g., structure 108) on the substrate 106.

The electromechanical arm 126 and/or the XYZ platform 128 (FIG. 1, FIG. 2, FIG. 3) may manipulate the relative positions of the substrate 106 (and therefore the structure 108) and the container 118 (and therefore the nozzle 122), such that the material may be selectively deposited and formed on the substrate 106, e.g., layer-by-layer in the z-direction, the x-direction, and/or the y-direction. Therefore, the structure 108 may be formed to have complex shapes and/or dimensions. Moreover, the chemical composition and the morphology (e.g., microstructure, density) of the material being formed can be adjusted, during the fabrication process, by modifying the composition of the electrolytic bath 120, or the parameters of the electrodeposition therefrom (e.g., current, voltage). Therefore, the systems of the disclosure are configured for selective modification of the composition and microstructure of the structure 108, including during the electrodeposition thereof.

Further, using multiple electrochemical cells 104 and/or multiple nozzles 122 in the system, multiple different structures 108 and/or multiple different materials for the same structure 108 may be simultaneously or sequentially fabricated. Accordingly, the less-porous zone 510 of the nuclear fuel element 500 of FIG. 5 may be electrodeposited through one nozzle 122 (in communication with one electrolytic bath 120 of an electrochemical cell 104) while another nozzle 122 (in communication with another electrolytic bath 120 of another electrochemical cell 104) electrodeposits the adjacent dense zone 512, in layer-by-layer fashion in the z-direction, before a third nozzle 122 (in communication with a third electrolytic bath 120 of a third electrochemical cell 104) electrodeposits the porous zone 508 on top of the less-porous zone 510, once the less-porous zone 510 has been fully electrodeposited. In another embodiment, the material of each of the porous zone 508, less-porous zone 510, and dense zone 512 may be deposited from the same electrolytic bath 120 and through the same or different nozzles 122, with the electrodeposition parameters adjusted, during the fabrication, to adjust the resulting porosity of the material being electrodeposited.

The embodiments of the disclosure are not limited to electrochemical cells 104 of a shape and structure illustrated in the figures. In other embodiments, for example, one or more of the electrochemical cells 104 of a system may be configured as syringes, with the body of the syringe providing the container 118 of the electrochemical cell 104, and the liquid contents of the syringe being formulated as the electrolytic bath 120. The rate of dispensation of the electrolytic bath 120 from a syringe-type electrochemical cell 104 may be controlled by controlling the rate of engagement of a plunger of the syringe, which rate of engagement may be controlled by a controller of the system (e.g., any of the aforementioned controllers or another controller).

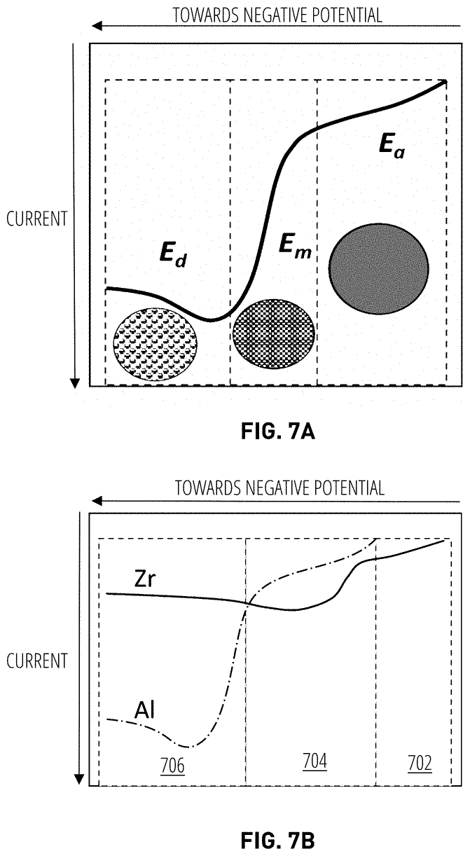

By way of example and not limitation, FIG. 7A and FIG. 7B are schematic polarization curves for the electrodeposition of aluminum and for the electrodeposition of an aluminum-zirconium alloy, respectively. In an electrodeposition process, the potential applied and the current flowed by the controller (e.g., controller 110 of FIG. 1 or first controller 204 of FIG. 2 or FIG. 3) to the electrochemical cell 104 may be varied, e.g., during the electrodeposition, to selectively tailor one or more of the morphology (e.g., shape, microstructure, density) and/or composition of the material of the structure 108 formed on the substrate 106. As illustrated in FIG. 7A, in a system for electrodepositing aluminum (e.g., the electrolytic bath 120 comprises aluminum ions), as the applied potential (e.g., voltage) and current flow is reduced, the aluminum deposited may vary between a substantially fully dense deposit in the region Eₐ, a porous deposit in region Eₘ, and a microsphere or dendrite deposit in region E_{d}. Therefore, the aluminum may be selectively deposited with a density/porosity gradient as the nozzle 122 is moved relative to the substrate 106, by controlling and adjusting the potential and/or current flow as the nozzle 122 is moved.

Similarly, the potential (e.g., voltage) applied and/or current flowed by the controller (e.g., the controller 110 of FIG. 1 or the first controller 204 of FIG. 2 or FIG. 3) to the electrochemical cell 104 may be varied, e.g., during the electrodeposition, to selectively tailor the relative composition of two or more elements being deposited from an electrolytic bath 120 by the system 100. As illustrated in FIG. 7B, for example, in a system with both zirconium and aluminum in the electrolytic bath 120, to deposit a structure 108 of an aluminum-zirconium alloy, the potential and current can be adjusted, e.g., during the electrodeposition, to adjust the relative composition of zirconium to aluminum in the electrodeposited material. Notably, as the applied potential and current is reduced, the relative composition of zirconium and aluminum may be tuned by varying the concentration ratio of their precursors and deposition regions where their deposition reaction kinetics has different potential-dependence. In some embodiments, only zirconium may be deposited from zone 702, aluminum and zirconium may be co-deposited with a greater concentration of zirconium than aluminum from zone 704, and aluminum and zirconium may be co-deposited with a greater concentration of aluminum than zirconium from zone 706.

The fabrication (e.g., flow) rate, or rate at which material may flow from the electrolytic bath 120, through the nozzle 122, to the substrate 106 (or the structure 108 thereon), may be varied by tailoring the size (e.g., opening) of the nozzle 122 and by adjusting the kinetics of the reaction including, but not limited to, adjusting the temperature of the heater 124 and/or adjusting the potential or current applied by the controller 110 (FIG. 1) or the first controller 204 FIG. 2, FIG. 3. In some embodiments, the size of the nozzle 122 may be adjusted (e.g., broadened or narrowed) during the electrodeposition by control via the controller 110 (or another controller of the system). For instance, physiochemical properties of the electrolytic bath 120 including, but not limited to, surface tension, viscosity, and diffusion coefficient are temperature dependent; accordingly, the process temperature may be varied, by controlling the heater 124, to selectively tailor the properties of the material deposited by the electrochemical processing unit (e.g., the electrochemical processing unit 102 (FIG. 1), the electrochemical processing unit 202 (FIG. 2), the electrochemical processing unit 302 (FIG. 3)).

A method of forming a third-dimensional structure (e.g., structure 108), which may be, for example, the nuclear fuel element 500 of FIG. 5, comprises providing the electrolytic bath 120 in the container 118 (e.g., receptacle). The electrolytic bath 120 comprises a metal salt of a metal to be deposited. As previously discussed, counter electrode 114 (and, optionally, the reference electrode 116) may be at least partially disposed in the electrolytic bath 120 and may be coupled (e.g., electrically coupled) to the substrate 106 disposed proximate the nozzle 122.

In embodiments in which the structure 108 to be formed (e.g., the nuclear fuel element 500 of FIG. 5) includes a nuclear material, a metal salt of a nuclear fuel metal may be dissolved in the electrolytic bath 120 and, during electrodeposition, may flow through the nozzle 122, as illustrated at arrow 602 of FIG. 6, and deposit on the surface of the substrate 106. As illustrated FIG. 4, the counter electrode 114 may comprise a material (A, B, or AB) similar to a material (A, B, or AB, respectively) of the structure 108 (e.g., the nuclear fuel element 500 (FIG. 5)) being formed. The electrolytic bath 120 may also comprise a material, such as a salt (e.g., A^{m+}, Bⁿ⁺, or A^{m+}+Bⁿ⁺) similar to the material (A, B, or AB, respectively) of counter electrode 114. For instance, each of the counter electrode 114, the electrolytic bath 120, and the structure 108 being formed may have at least one element in common.

In operation, an electric current flow and/or a voltage difference may be applied between the substrate 106 (e.g., the working electrode) and its corresponding counter electrode 114, resulting in the electrodeposition of a material (e.g., a metal) derived from one or more salts (e.g., metal salts) dissolved in the electrolytic bath 120. The voltage difference and/or current flow may be varied, e.g., for and/or during deposition, to selectively tailor at least one of a morphology (e.g., a microstructure, a density, a porosity) and/or a composition (e.g., relative concentration of one element of an alloy to another element of the alloy) of the deposited material (e.g., metal). Ire addition, the temperature of the heater 124 may be varied, e.g., for and/or during deposition, to selectively tailor a physiochemical property of the metal salt as the metal salt flows through the nozzle 122. As illustrated in FIG. 4, the system may be configured with more than one electrochemical cell 104 to enable electrodeposition of more than one material concurrently.

While the system (e.g., system 100 of FIG. 1, system 200 of FIG. 2, system 300 of FIG. 3, system 400 of FIG. 4) and methods have been described with respect to formation of a nuclear fuel element (e.g., the nuclear fuel element 500 of FIG. 5), the present disclosure is not so limited. Any of the systems and/or methods may be used to manufacture other functional materials and components, such as light-weight aluminum alloys and magnesium alloys; and/or high performance materials, components, and/or devices for energy storage and environmental control, including, but not limited to, catalysts, fuel cell electrodes, batteries, and sensors. The systems and/or methods may also be used for surface printing and coating of devices for the electronics and automotive industries.

While embodiments of the disclosure may be susceptible to various modifications and alternative forms, specific have been described in detail herein. However, it should be understood that the disclosure is not limited to the particular forms disclosed. Rather, the disclosure encompasses all modifications, variations, combinations, and alternatives falling within the scope of the disclosure as defined by the following appended claims and their legal equivalents.

1. An electrodeposition system for additive manufacturing of a three-dimensional structure, the electrodeposition system comprising:
at least one electrochemical cell comprising:
a receptacle containing an electrolytic bath;
at least one nozzle opening from the receptacle toward and proximate a substrate configured as a working electrode of the at least one electrochemical cell; and
a counter electrode disposed in the electrolytic bath.

2. The electrodeposition system of claim 1, further comprising at least one of an electromechanical arm and an XYZ platform configured to control relative movement between the at least one nozzle and the substrate.

3. The electrodeposition system of claim 1, further comprising at least one controller configured to apply a current or voltage to the counter electrode and the substrate configured as the working electrode.

4. The electrodeposition system of claim 1, wherein the electrolytic bath comprises an ionic liquid and at least one a nuclear fuel material salt dissolved in the ionic liquid.

5. The electrodeposition system of claim 1, wherein the electrolytic bath comprises an ionic liquid and at least one of a uranium salt and a zirconium salt dissolved in the ionic liquid.

6. The electrodeposition system of claim 1, further comprising a heater disposed about the at least one nozzle, the substrate, or both.

7. The electrodeposition system of claim 1, wherein each of the receptacle and the substrate are movable in three dimensions.

8. The electrodeposition system of claim 1, wherein the electrodeposition system comprises a plurality of the electrochemical cells, each electrolytic bath of the electrochemical cells having a different chemical composition.

9. The electrodeposition system of claim 1, wherein the electrodeposition system further comprises a plurality of controllers, the plurality of controllers comprising:
at least one controller configured to control a voltage difference and a current flow between the counter electrode and the substrate configured as the working electrode; and
at least one other controller configured to control movement of the at least one nozzle over the substrate.

10. The electrodeposition system of claim 1, wherein the at least one nozzle is movable in three dimensions relative to the substrate.

11. A method of forming a three-dimensional structure, comprising:
providing an electrolytic bath in a receptacle, the electrolytic bath comprising a metal salt;
disposing a counter electrode at least partially within the electrolytic bath;
coupling the counter electrode to a working electrode; and
flowing the metal salt through a nozzle coupled to the receptacle to deposit, on a surface of the working electrode, a metal of the metal salt.

12. The method of claim 11, further comprising, while flowing the metal salt through the nozzle, applying a voltage difference between the working electrode and the counter electrode and flowing a current between the working electrode and the counter electrode.

13. The method of claim 12, further comprising, during the flowing, varying the voltage difference and the current between the working electrode and the counter electrode to selectively vary at least one of a microstructure of the metal, a density of the metal, a porosity of the metal, and a composition of the metal.

14. The method of claim 11, further comprising, during the flowing, varying a temperature of a heater disposed about the nozzle or about the working electrode to selectively vary a physiochemical property of the metal salt as the metal salt flows through the nozzle.

15. The method of claim 11, wherein the metal salt comprises uranium or plutonium.

16. The method of claim 12, further comprising, during the flowing, varying the voltage difference and the current between the working electrode and the counter electrode to selectively vary a porosity of the metal and form the metal in neighboring zones of the three-dimensional structure, the metal of each of the neighboring zones exhibiting a different porosity.

17. The method of claim 11, further comprising:
providing an additional electrolytic bath in an additional receptacle, the additional electrolytic bath comprising an additional metal salt;
disposing an additional counter electrode at least partially within the additional electrolytic bath;
coupling the additional counter electrode to the working electrode; and
flowing the additional metal salt through an additional nozzle coupled to the additional receptacle to deposit, on the surface of the working electrode, an additional metal of the additional metal salt.

18. The method of claim 17, wherein the additional metal salt is flowed through the additional nozzle while the metal salt is flowed through the nozzle to simultaneously deposit the metal and the additional metal on the surface of the working electrode.

19. The method of claim 11, wherein the flowing is performed at a temperature of 80° C. or less.

20. An electrodeposition system for additive manufacturing of a three-dimensional nuclear fuel element, the electrodeposition system comprising:
a plurality of electrochemical cells, each electrochemical cell of the plurality comprising:
a receptacle comprising an electrolytic bath;
at least one nozzle opening from the receptacle towards a working electrode of the electrochemical cell; and
a counter electrode extending into the electrolytic bath,
each electrolytic bath of the system comprising a different composition of nuclear fuel material salt dissolved in ionic liquid at a temperature of less than about 80° C.; and
the working electrode extending below the at least one nozzle of all of the plurality of electrochemical cells.
